(19) United States
(12) Patent Application Publication
(10) Pub. No.: US 2008/0137663 A1
(43) Pub. Date: Jun. 12, 2008

(54) IDENTIFIER VERIFICATION METHOD IN PEER-TO-PEER NETWORKS

(75) Inventors: Ja Beom Gu, Seoul (KR); Jae Hoon Nah, Daejeon (KR); Hyeok Chan Kwon, Daejeon (KR); Jong Soo Jang, Daejeon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon (KR)

(21) Appl. No.: 11/845,052

(22) Filed: Aug. 25, 2007

(30) Foreign Application Priority Data
Dec. 6, 2006 (KR) 10-2006-122979
May 9, 2007 (KR) 10-2007-45194

(51) Int. Cl. H04L 12/28

(52) U.S. Cl. 370/395.3

(57) ABSTRACT

An identifier verification method for determining whether an identifier of a second peer node is reliable, at first peer node, in a distributed peer to peer network without a server, the network having a plurality of peer nodes connected to an Internet, the identifier verification method including: obtaining the identifier of the second peer node; requesting identifier verification for checking whether the identifier of the second peer node is forged, by using a cryptographic method via a third peer node randomly selected, when receiving a request for the identifier verification from a user; and verifying reliability of the identifier of the second peer node depending on a result of the identifier verification request.

### CROSS-REFERENCE TO RELATED APPLICATIONS

This application claims the priority of Korean Patent Application Nos. 2006-122979 filed on Dec. 6, 2006 and 2007-45194 filed on May 9, 2007, in the Korean Intellectual Property Office, the disclosure of which is incorporated herein by reference.

### BACKGROUND OF THE INVENTION

1. Field of the Invention

The present invention relates to security in communication and interaction among heterogeneous devices on a computer network, and more particularly, an identifier verification method and apparatus for establishing reliable communication and interactive infrastructure for nodes in a peer to peer (P2P) network.

2. Description of the Related Art

Peer to peer (P2P) networking is a very generic concept encompassing sharing of a system or network resource among a plurality of computing nodes. These computing nodes are referred to as peers as opposed to exiting servers or clients. Here, the resource is all-inclusive of a variety of factors such as computing power of peers, networking operation, and battery. Also, the sharing means not just copying of files but also effective distribution/search/acquisition of the resource.

Therefore, peers of the P2P network collaborate and interact with one another to share the resource effectively. This P2P network is generally formed of numerous peers, and respective peers are scattered on a global Internet and connected via an Internet network.

In implementing a global-scale P2P network, it is crucial to assign a unique identifier to each of the peers and their shared resource and mange the identifier. Notably, in the P2P network, only information for identifying a counterpart peer is the identifier and the P2P network operation is dependent on the identifier. Accordingly, management of the identifiers is intimately related to security of the P2P network. Therefore, to build a secure network environment, the P2P nodes should determine whether the identifiers are reliable, at any time.

However, so far, the P2P network has focused identifier management chiefly on pinpointing location of the peers and resource via the identifiers, while not addressing reliability of the information. Moreover, users can join and leave the P2P network freely and the P2P network does not act as a management server or plays a very limited role thereof. In addition, the P2P network generates the identifiers without limits, thereby rendering it hard to determine whether the identifiers are reliable.

As a result, the P2P network is vulnerable in terms of the identifier-related security, thus entailing problems of mis-route, deceit, and interruption caused by forgery of the identifiers. This accordingly has called for a technology for detecting possible forgery of the identifiers and ensuring reliability thereof.

### SUMMARY OF THE INVENTION

An aspect of the present invention provides an identifier verification method for detecting possible forgery of identifiers without an aid of a management server (or manager) to solve security problems with the identifiers in a serverless distributed P2P network.

An aspect of the present invention also provides an identifier verification method for precluding attacks such as mis-rout, deceit and interruption caused by forgery of the identifiers in a process where a node of a serverless distributed P2P network obtains an identifier of a peer node thereof or in a communication process thereafter.

According to an aspect of the present invention, there is provided an identifier verification method for determining whether an identifier of a second peer node is reliable, at first peer node, in a distributed peer to peer network without a server, the network having a plurality of peer nodes connected to an Internet, the identifier verification method including: obtaining the identifier of the second peer node; requesting identifier verification for checking whether the identifier of the second peer node is forged, by using a cryptographic method via a third peer node randomly selected, when receiving a request for the identifier verification from a user; and verifying reliability of the identifier of the second peer node depending on a result of the identifier verification request.

According to another aspect of the present invention, there is provided an identifier verification method in a peer to peer network, a distributed peer to peer network without a server, the server having a plurality of peer nodes connected to an Internet, the identifier verification method including: transmitting and receiving an identifier verification request message and a response message to obtain an identifier of a counterpart second peer node, the transmitting and receiving performed by a first peer node; transmitting an identifier proxy verification request message to a third peer node randomly selected, the transmitting performed by the first peer node; transmitting an identifier proxy verification transmission message to the second peer node when the third peer node receives the identifier proxy verification request message, the transmitting performed by the third peer node; transmitting an identifier verification authentication message including authentication information obtained by performing the identifier verification authentication to the first peer node when the second peer node receives the identifier proxy verification transmission message, the transmitting performed by the second peer node; and determining whether the identifier of the second peer node is reliable depending on the authentication information obtained from the identifier verification authentication message, the determining performed by the first peer node.

### BRIEF DESCRIPTION OF THE DRAWINGS

The above and other aspects, features and other advantages of the present invention will be more clearly understood from the following detailed description taken in conjunction with the accompanying drawings, in which:

The above and other aspects, features and other advantages of the present invention will be more clearly understood from the following detailed description taken in conjunction with the accompanying drawings, in which:

FIG. 1 is a configuration view illustrating a peer-to-peer (P2P) network for applying exemplary embodiments of the invention;

FIG. 2 illustrates a process in which a peer node verifies an identifier of another peer node in a peer-to-peer network according to an exemplary embodiment of the invention;

FIG. 3 illustrates a process in which a first peer node performs identifier verification according to an exemplary embodiment of the invention;

FIG. 4 illustrates a process in which a first peer node receives an identifier of a second peer node during identifier verification according to an exemplary embodiment of the invention;

FIG. 5 illustrates a process in which a second peer node performs identifier verification response according to an exemplary embodiment of the invention;

FIG. 6 illustrates a process in which a first peer node requests identifier proxy verification according to an exemplary embodiment of the invention;

FIG. 7 illustrates a process in which a third peer node performs identifier proxy verification according to an exemplary embodiment of the invention;

FIG. 8 illustrates a process in which a second peer node performs identifier verification authentication according to an exemplary embodiment of the invention; and

FIG. 9 illustrates a process in which a first peer node determines whether identifier verification is reliable according to an exemplary embodiment of the invention.

### DETAILED DESCRIPTION OF THE PREFERRED EMBODIMENT

Exemplary embodiments of the present invention will now be described in detail with reference to the accompanying drawings. In the following description, well-known functions and construction are not described in detail since they would obscure the intention in unnecessary detail.

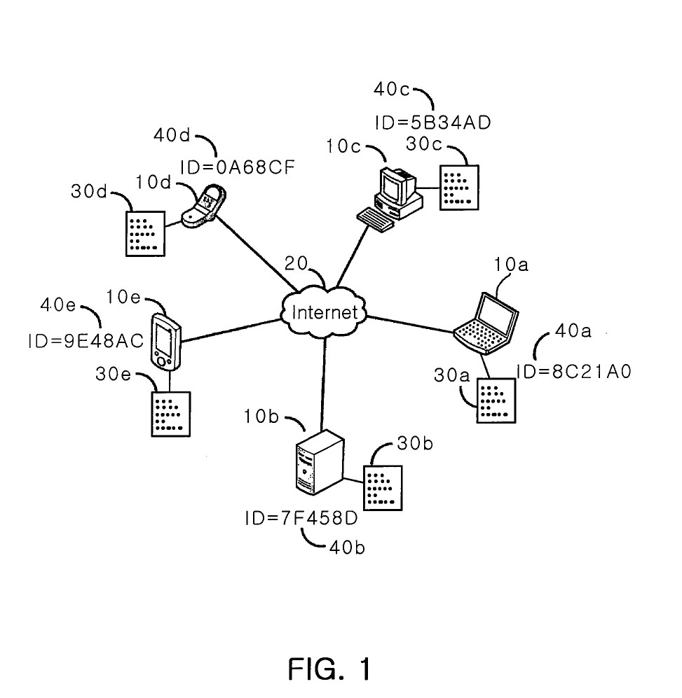

According to exemplary embodiments of the present invention, a description will be given of a cryptographically robust identifier verification method for increasing a successful verification rate by using a serverless distributed peer to peer (P2P) network. First, a P2P network structure for applying the present embodiment will be described with reference to FIG. 1 and identifier verification operations in the P2P network will be explained according to an exemplary embodiment of the invention.

Referring to FIG. 1, a plurality of peer nodes 10a to 10e are interconnected via an Internet 20. Each of the peer nodes 10a to 10e has a local peer identifier list 30a to 30e including a unique identifier 40a to 40e thereof in a network. Here, the identifier 40a to 40e is generally formed of numbers or strings, and identifier information is exchanged by a function of seeking for a peer from the identifier or obtaining the identifier of the peer. Specific use and types of these identifiers 40a to 40e may vary according to characteristics of the P2P network, and the present embodiment is not limited to a specific P2P network.

The peer nodes 10a to 10e may be present on an identical subnet and be distributed across the world, directly and indirectly connected with one another. For example, when one 10a of the nodes is to transmit data to the other node 10c, the node 10b may function to transmit the data. Moreover, each of the peer nodes 10a to 10e is located differently, thus gathering information about the other peer nodes. The information gathered in this fashion is managed as peer identifier lists 30a to 30e by the peer nodes 10a to 10e, respectively. These respective peer identifier lists 30a to 30e are subsets of the peers present in the entire P2P network. One of the peer identifier lists may be different from the other peer identifier list.

The peer node 10a to 10e generally may be Internet-connectable computers and communication devices such as personal computers (PC), personal digital assistants (PDAs), lap top computers, servers and mobile phones. Specific methods for connecting these computers and communication devices to the Internet do not affect the scope of the invention. Also, a resource shared by collaboration among the peer nodes in the specific P2P network may vary according to characteristics of the network, and the present embodiment is not limited to the specific P2P network as described above.

The peer node 10a to 10e does not function as a management server (or manager). Therefore, due to absence of the management regulation, the peer node 10a to 102 may join or leave the network at any time.

An identifier verification method in the P2P network configured as above will be described according to an exemplary embodiment of the invention. First, operations of one peer node verifying an identifier of the other peer node will be described in detail.

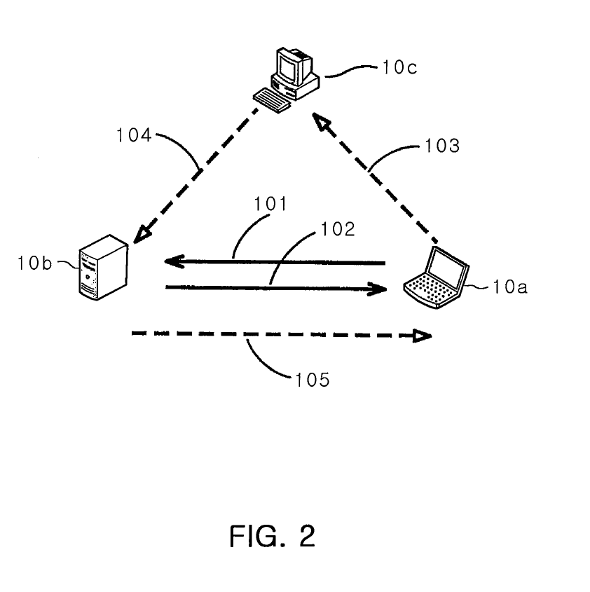

FIG. 2 illustrates a process in which one peer node verifies an identifier of the other peer node in the P2P network according to an exemplary embodiment of the invention.

Referring to FIG. 2, in operation 101, a first peer node 10a of a P2P network transmits an initial identifier verification request message to a second peer node 10b whose identifier is to be verified. In operation 101, the second peer node 10b transmits an identifier verification response message to the first peer node 10a.

Then, in operation 103, the first peer node 10a randomly selects a third peer node 10c, a proxy verifier, in a peer identifier list, and transmits an identifier proxy verification message to the selected third peer node 10c. Accordingly, in operation 104, the third peer node 10c transmits an identifier proxy verification transmission message to the second peer node 10b.

Thereafter, in operation 105, the second peer node 10b transmits an identifier verification authentication message to the first peer node 10a. In turn, the first peer node 10a interprets the identifier verification authentication message and identifies an identifier verification result of the second peer node 10b.

Then, the operations described above will be explained in detail.

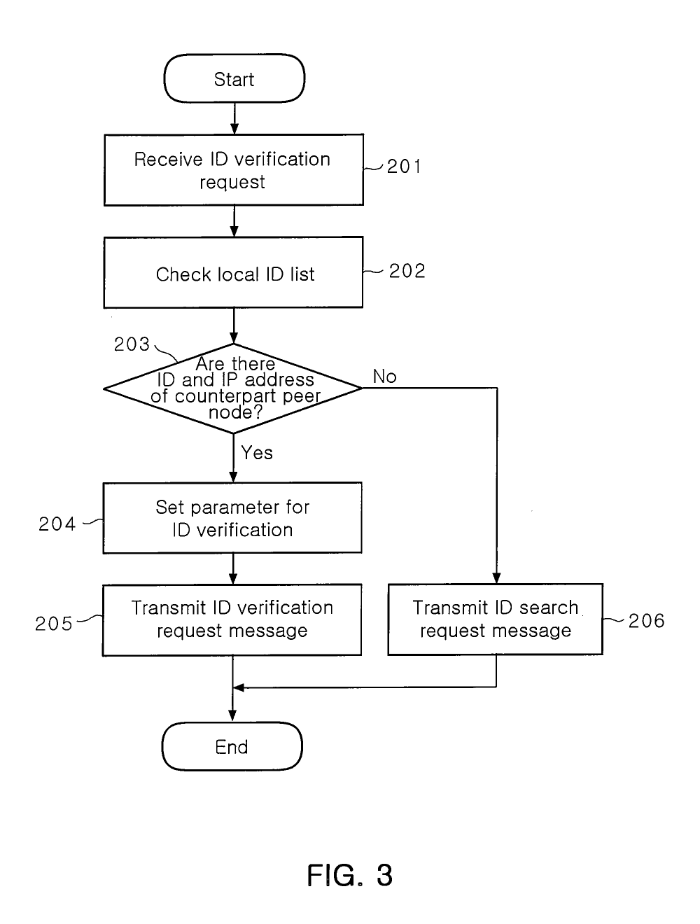

In the operations, the first peer node 10a performs identifier verification and determines whether the identifier of the second peer node 10b is forged, thereby verifying reliability of the identifier. Operations of the first peer node 10a performing the identifier verification will be described with reference to FIG. 3. Here, each of the peer nodes is configured as a general user-operated computer device, to which the user's request is transferred by an appropriate user interface and in which information of the computer device is displayed on the user also by the appropriate user interface.

Referring to FIG. 3, in operation 201, the first peer node 10a receives a request for verifying the identifier of the second peer node 10b from the user. Inoperation 202, the first peer node 10a checks a local peer identifier list. Then in operation 203, the first peer node 10a checks whether there are the identifier and an IP address of the second peer node 10b whose identifier is to be verified. When there is the identifier of the second peer node 10b in the list, in operation 204, the first peer node 10a sets a parameter necessary for identifier verification. In operation 205, the first peer node 10a transmits the identifier verification request message to the second peer node 10b.

Meanwhile, when there is no identifier of the second peer node 10b in operation 203, the first peer node 10a transmits an identifier search request message in operation 206. Here, the identifier search request message is transmitted typically by broadcasting, which may be implemented by various methods. The present embodiment is not limited to a specific P2P identifier search method.

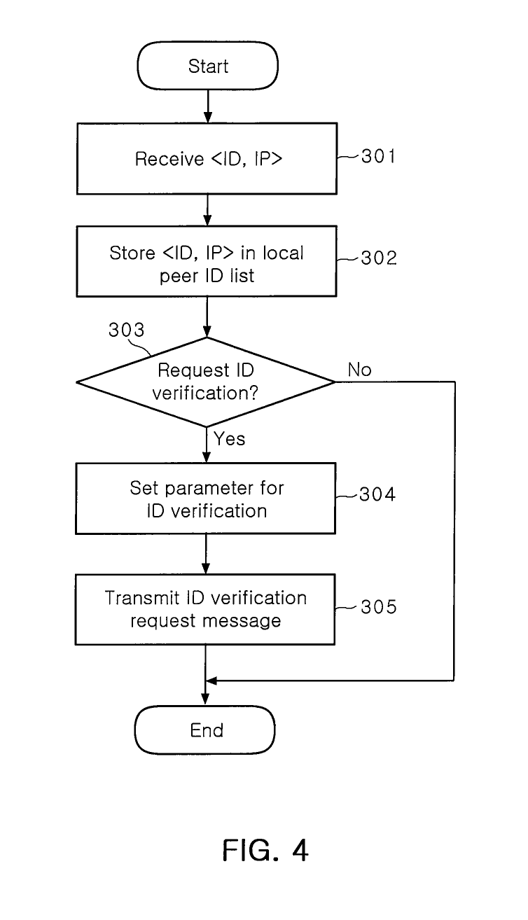

Next, a description will be given in detail of operations of the first peer node receiving a result of the identifier search request during identifier verification according to an exemplary embodiment of the invention with reference to FIG. 4.

In operation 301, the first peer node 10a receives the identifier and IP address of the second peer node 10b newly searched in response to the identifier search request message. In operation 302, the first peer node 10a stores the received identifier and IP address in the local peer identifier list. Here, such an identifier response message may be transmitted by a variety of peer nodes constituting the P2P network as shown in FIG. 1 and by various methods. The present embodiment is not limited to a specific P2P identifier response method.

Then, in operation 303, the first peer node 10a checks whether capable of verifying the received identifier at the request of the user. In a case where the first peer node 10a is not capable of performing the identifier verification, the first peer node 10a finishes the operation immediately. On the other hand, in a case where the first peer node 10a is capable of performing the identifier verification, in operation 304, the first peer node 10a sets a parameter necessary for the identifier verification and in operation 305, transmits the identifier verification request message to the second peer node 10b.

To set the parameter necessary for the identifier verification, the first peer node 10a generates a session identifier sid by Equation 1:

sidᵢ=h(IDᵢ|0|0|Nᵢ|IPᵢ) Equation 1

where h denotes a cryptographic hash function, and IDᵢ denotes an identifier of the first peer node 10a. “|” denotes a connection between a first string and a second string. Connecting the first string to a string marked with 0 is the same as connecting the first string to nothing. The first peer node 10a generates the session identifier with second and third strings set to 0. Nᵢ denotes a random one-time string (nonce) and IPᵢ denotes an Internet Protocol (IP) address of the first peer node 10a.

Also, the identifier verification request message generated by the first peer node 10a and transmitted to the second peer node 10b has a format satisfying Equation 2:

<“request”|IDᵢ|IDₜ|Nᵢ> Equation 2

where “request” denotes a string indicating that the message is for the identifier verification request, IDᵢ denotes the identifier of the first peer node 10a, IDₜ denotes the identifier of the second peer node 10b whose identifier is to be verified, and Nᵢ denotes a random one-time random string identical to the string of the afore-mentioned Equation 1.

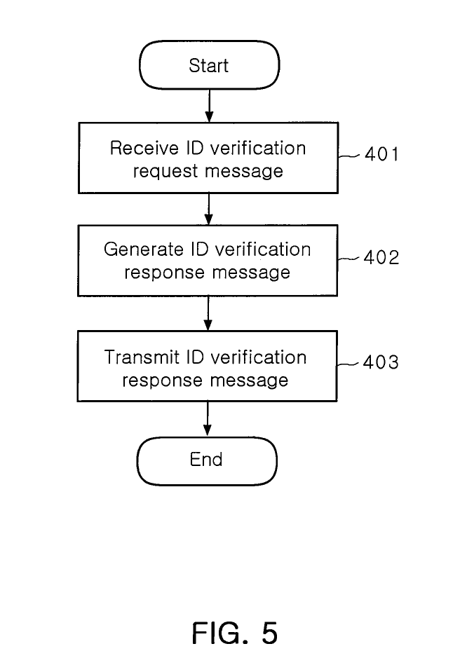

Operations of the second peer node receiving the identifier verification request message will be described in detail with reference to FIG. 5.

Referring to FIG. 5, in operation 401, the second peer node 10b receives the identifier verification request message from the first peer node 10a. In operation 402, the second peer node 10b checks the received identifier verification request message and in turn generates an identifier verification response message. Then, in operation 403, the second peer node 10b transmits the generated identifier verification response message to the first peer node 10a.

To generate the identifier verification response message in operation 402, the second peer node 10b generates a session identifier thereof by Equation 3 below.

sidₜ=h(IDₜ|Pₜ|Nᵢ|NₜIPₜ) Equation 3,

where h denotes a cryptographic hash function, IDₜ denotes the identifier of the second peer node 10b, “|” denotes a connection between a first string and a second string, Pₜ denotes a public key self-generated by the second peer node 10b, Nᵢ denotes a random one-time string included in the identifier verification request message of Equation 2, and Nₜ denotes a random one-time string generated by the second peer node 10b. The second peer node 10b also generates the session identifier sidᵢ identical to the session identifier generated by the first peer node 10a according to Equation 1. Information necessary for the second peer node 10b to generate the session identifier sidᵢ is included in the identifier verification request message received in operation 401.

The identifier verification response message generated from the second peer node 10b has a format satisfying Equation 4.

<“response”|sidₜ|PₜE_{P}_{ᵢ}(Nₜ|S_{R}_{ₜ}(sidₜ|sidᵢ)> Equation 4

where “response” denotes a string indicating that the message is for the identifier verification response, sidₜ denotes the session identifier of the second peer node 10b, Pₜ and Rₜ denote a pair of the public key and a private key self-generated by the second peer node 10b. Eₚ_{ᵢ}(Nₜ) denotes the random one-time string encrypted using a public key Pᵢ of the first peer node 10a and S_{R}_{ₜ}(sidₜ|sidᵢ) denotes an electronic signature value generated by the second peer node 10b.

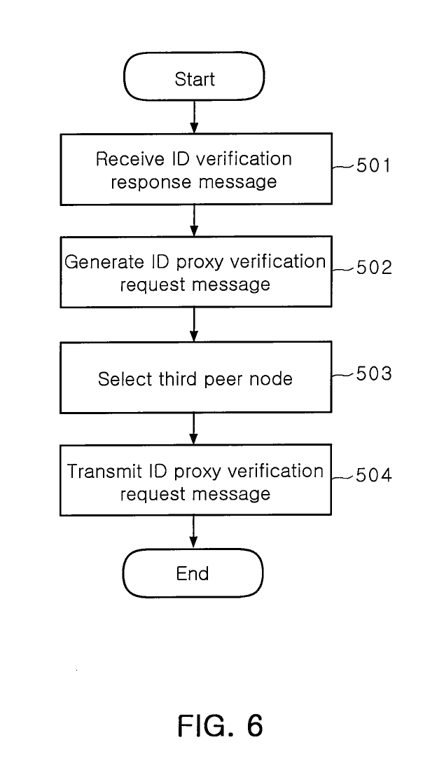

Operations of the first peer node receiving the identifier verification response message will be described with reference to FIG. 6.

Referring to FIG. 6, in operation 501, the first peer node 10a receives the identifier verification response message from the second peer node, and in operation 502, generates the identifier proxy verification request message in response to the identifier verification response message. Then, in operation 503, the first peer node 10a randomly selects the third peer node 10c from a peer identifier list thereof. Subsequently, in operation 504, the first peer node 10a transmits the generated identifier proxy verification request message to the selected third peer node 10c.

To generate the identifier proxy verification message in operation 502, the first peer node 10a generates a key value k by following Equation 5:

k=E_{P}_{ₜ}(Nᵥ|Nₜ) Equation 5,

where Nᵥ denotes a random one-time string newly generated by the first peer node 10a for identifier verification.

Also, the identifier proxy verification request message has a format satisfying following Equation 6:

<“delegate_request”|sidₜ|sid_{d}|sidᵢ|k|Pᵢ|S_{R}_{ᵢ}(sidₜ|sid_{d}|sidᵢ)> Equation 6,

where “delegate_request” denotes a string indicating that the message is for the identifier proxy verification request, sidₜ denotes the session identifier of the second peer node 10b received according to Equation 4, sid_{d} denotes a session identifier of the third peer node 10c, sidᵢ denotes the session identifier of the first peer node 10a generated according to Equation 1, k denotes a key value generated according to Equation 5, Pᵢ and Rᵢ denote a pair of a public key and a private key self-generated by the first peer node 10a, and S_{R}_{ᵢ}(sidₜ|sid_{d}|sidᵢ) denotes an electronic signature value generated by the first peer node 10a.

In operation 503, the first peer node 10a randomly selects the third peer node from the peer identifier list thereof. The third peer node 10c selected as an identifier proxy verifier generates an identifier sid_{d} thereof by Equation 7:

sid_{d}=h(ID_{d}|0|0|0|IP_{d}) Equation 7,

where ID_{d} denotes the identifier of the third peer node, and IP_{d} denotes an IP address of the third peer node.

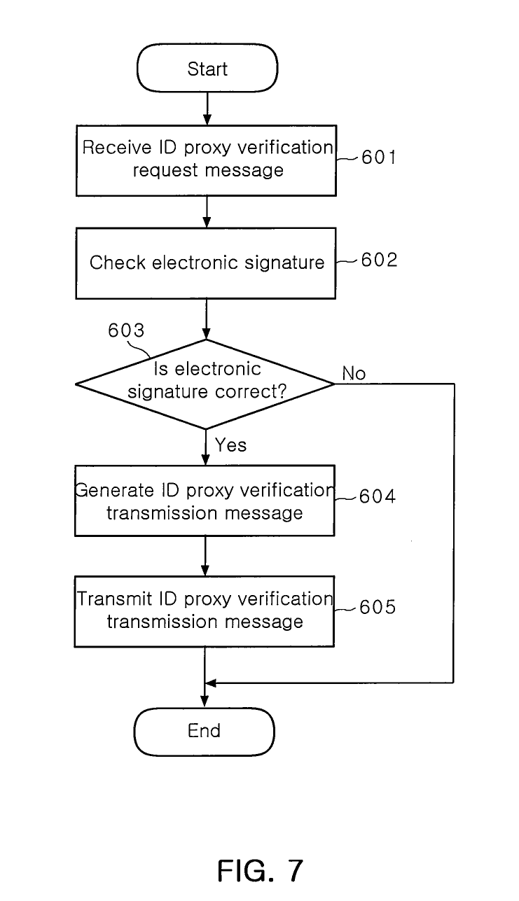

A description will be given in detail of operations of the third peer node 10c receiving the identifier proxy verification request message transmitted from the first peer node 10a, with reference to FIG. 7.

Referring to FIG. 7, in operation 601, the third peer node 10c acts as an identifier proxy verifier for the first peer node 10b when receiving the identifier proxy verification request message from the first peer node 10a.

Accordingly, in operation 602, the third peer node 10c checks electronic signature included in the identifier proxy verification message, and in operation 603, determines whether the electronic signature is correct. When the third peer node 10c determines the electronic signature to be not correct, the third peer node 10c finishes the operation. Meanwhile, when the third peer node 10c determines the electronic signature to be correct, in operation 604, the third peer node 10c generates an identifier proxy verification transmission message and transmits the identifier proxy verification transmission message generated in operation 605 to the second peer node 10b. Through this operation of transmitting the identifier proxy verification transmission message, the key value k is indirectly transmitted to the second peer node 10b. The third peer node 10c generates the identifier proxy verification transmission message by following Equation 8.

<“foward_delegate_|request”|sidₜ|sidₜ|sid_{d}|k|P_{d}|S_{R}_{_{d}}(sidₜ|sidₜ|sid_{d})> Equation 8,

where “foward_delegate_request” denotes a string indicating that the message is for the identifier proxy verification transmission, sidₜ denotes the session identifier of the second peer node 10b received according to Equation 6, sid_{d} denotes a session identifier of the third peer node 10c, k denotes the key value received according to Equation 6, P_{d} and R_{d} denote a pair of a public key and a private key generated by the third peer node 10c, and S_{R}_{_{d}}(sidₜ|sidₜ|sid_{d}) denotes an electronic signature value generated by the third peer node 10c.

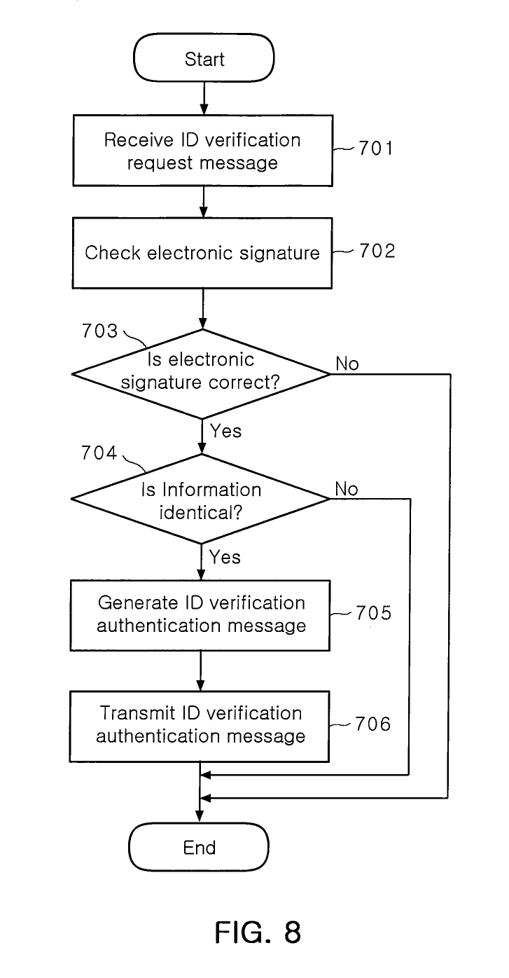

The identifier proxy verification transmission message generated in this fashion is transmitted to the second peer node 10b and subsequent operations of the second peer node 10b will be described in detail with reference to FIG. 8.

Referring to FIG. 8, in operation 701, the second peer node 10b receives the identifier proxy verification transmission message and in operation 702, checks electronic signature included in the identifier proxy verification transmission message.

Then in operation 703, the second peer node 10b determines whether the checked electronic signature is correct. When the electronic signature is determined to be not correct, the second peer node 10b finishes the operation. Meanwhile, when the electronic signature is determined to be correct, in operation 704, the second peer node 10b checks whether information included in the identifier proxy verification transmission message is identical to information included in the identifier verification request message. When the two information are not identical to each other, the second peer node 10b finishes the operation. Meanwhile, when the two information are identical to each other, the second peer node 10b generates an identifier verification authentication message in operation 705 and transmits the generated identifier verification authentication message to the first peer node 10a in operation 706.

When generating the identifier verification message in operation 704, the second peer node 10b decodes the key value k included in the identifier proxy verification transmission message using the private key Rₜ thereof to obtain an Nₓ value according to Equation 5, and checks whether the Nₜ value1 is identical to the value self-generated by Equation 3. An authentication value pr authenticated by this checking is obtained by Equation 9. Here, the authentication value pr is included in the identifier verification authentication message.

pr=h(sidₜ|sidᵢ|Nᵥ) Equation 9,

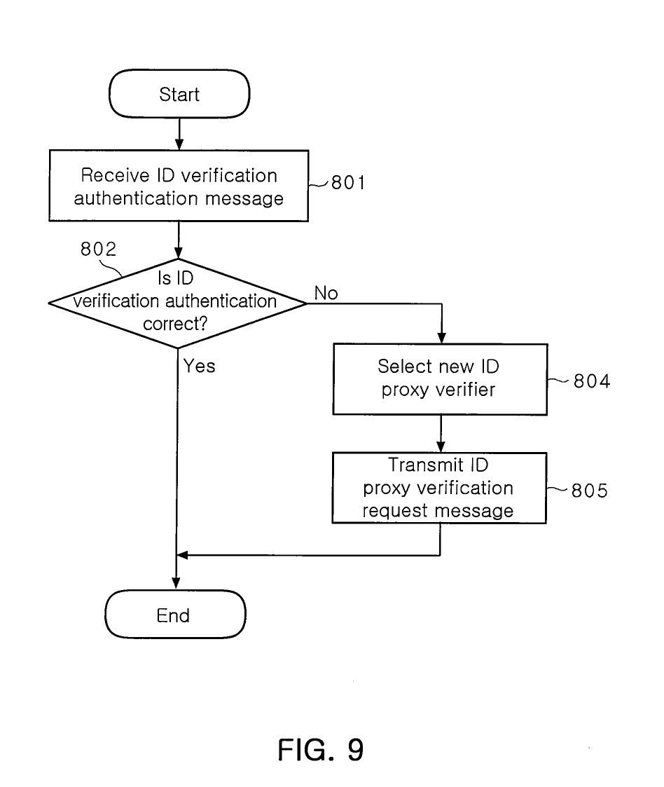

When receiving the identifier verification authentication message from the second peer node 10a in this fashion, the first peer node 10c performs operations as shown in FIG. 9.

Referring to FIG. 9, in operation 801, the first peer node 10a receives the identifier verification authentication message from the second peer node 10b, and in operation 802, identifies the authentication value pr included in the identifier verification authentication message, and checks whether the identification verification authentication is performed correctly, thereby determining whether the identifier is reliable. When the identifier verification authentication is performed correctly, that is, the authentication value indicates a success of the authentication verification, the first peer node 10a notifies the user of the success of the identifier verification and finishes the identifier verification operation. On the other hand, when the identifier verification authentication is not performed correctly, in operation 804, the first peer node 10a notifies the user of a failure of the identification verification and randomly selects a new proxy verifier (peer node). Then in operation 805, the first peer node transmits the identifier proxy verification request message to the selected new verifier. Accordingly, the first peer node may perform the operations described above to request the second peer node for the identifier verification via the selected new proxy verifier.

Selection of the new proxy verifier and subsequent repetition of the identifier verification as described above serve as a follow-up measure against failed verification and constitute a significant feature of the invention, thereby enhancing reliability of the identifier verification. That is, even when the identifier verification result is successful, the firs peer node 10a may repeat the identifier verification. Particularly, the identifier verification is repeated three and four time but may be performed regularly or irregularly during future communication between the first peer node 10 and the second peer node 10b, thereby further increasing reliability. Specific implementation methods thereof may vary and will not be explained in the present embodiment.

As set forth above, according to exemplary embodiments of the invention, peers in a serverless P2P network are guaranteed with reliable identifiers. Also, reliability of the peers may be checked immediately if necessary, thereby suitable for the P2P network with numerous nodes. Moreover, one or more identifiers of the serverless P2P network are prevented from being forged by an attacker, thereby precluding attacks such as mis-route, deceit and interruption.

While the present invention has been shown and described in connection with the exemplary embodiments, it will be apparent to those skilled in the art that modifications and variations can be made without departing from the spirit and scope of the invention as defined by the appended claims.

What is claimed is:

1. An identifier verification method for determining whether an identifier of a second peer node is reliable, at first peer node, in a distributed peer to peer network without a server, the network having a plurality of peer nodes connected to an Internet, the identifier verification method comprising:
obtaining the identifier of the second peer node;
requesting identifier verification for checking whether the identifier of the second peer node is forged, by using a cryptographic method via a third peer node randomly selected, when receiving a request for the identifier verification from a user; and
verifying reliability of the identifier of the second peer node depending on a result of the identifier verification request.

2. The identifier verification method of claim 1, wherein the obtaining the identifier of the second peer node comprises:
searching the identifier of the second peer node in a local peer identifier list thereof;
transmitting an identifier verification request message for obtaining the identifier of the second peer node when there is no identifier of the second peer node in the list;
receiving the identifier and an Internet protocol (IP) address of the second peer node via an identifier response message from the second peer node;
storing the identifier and the IP address in the local peer identifier list; and
setting a parameter necessary for the identifier verification using the identifier of the second peer node stored in the local peer identifier list.

3. The identifier verification method of claim 2, wherein the identifier verification request message comprises the parameter necessary for the identifier verification and has a format satisfying following Equation 2:
<“request” |IDᵢ|IDₜ|Nᵢ> Equation 2,
where “request” denotes a string indicating that the message is for the identifier verification request, IDᵢ denotes an identifier of the first peer node, IDₜ denotes the identifier of the second peer node and Nᵢ denotes a random one-time string.

4. The identifier verification method of claim 2, wherein the setting a parameter necessary for the identifier verification comprises generating a session identifier thereof to set the parameter.

5. The identifier verification method of claim 2, wherein the identifier verification response message comprises a session identifier of the second peer node and the session identifier of the first peer node.

6. The identifier verification method of claim 5, wherein the identifier verification response message has a format satisfying following Equation 4:
<“response”|sidₜPₜ|E_{P}_{ᵢ}(Nₜ|S_{R}_{ₜ}(sidₜ|sidᵢ)> Equation 4,
where “response” denotes a string indicating that the message is for the identifier verification response, Nₜ denotes a random one-time string, Pₜ and Rₜ denote a pair of a public key and a private key generated by the second peer node, E_{P}_{ᵢ}(Nₜ) denotes the random one-time string encrypted using a public key of the first peer node, and S_{R}_{ₜ}(sidₜ|sidᵢ) denotes an electronic signature value.

7. The identifier verification method of claim 5, wherein the session identifier of the first peer node is generated by Equation 1:
sidᵢ=h(IDᵢ|0|0|Nᵢ|IPᵢ) Equation 1,
where h denotes a cryptographic hash function, IDᵢ denotes the identifier of the first peer node, Pₜ denotes the public key self-generated by the second peer node, Nᵢ denotes a random one-time string and IPᵢ denotes an IP address of the first peer node.

8. The identifier verification method of claim 5, wherein the session identifier of the second peer node is generated by Equation 3:
sidₜ=h(IDₜ|Pₜ|Nᵢ|Nₜ|IPₜ) Equation 3,
where h denotes a cryptographic hash function, IDₜ denotes the identifier of the second peer node, Nₜ denotes a random one-time string generated by the second peer node, IPₜ denotes an IP address of the second peer node.

9. The identifier verification method of claim 1, wherein the requesting identifier verification for checking whether the identifier of the second peer node is forged comprises:
requesting the identifier verification via the third peer node to the second peer node by transmitting an identifier proxy verification request message to the third peer node;
receiving an identifier verification authentication message including authentication information obtained by performing the identifier verification authentication, from the second peer node; and
determining whether the identifier of the second peer node is reliable using the authentication information included in the identifier verification authentication message received from the second peer node.

10. The identifier verification method of claim 9, wherein the requesting the second peer node for the identifier verification comprises:
generating a key value when receiving an identifier verification response from the second peer node;
generating the identifier proxy verification message including the generated key value;
selecting the third peer node for the identifier proxy verification from the local peer identifier list; and
transmitting the generated identifier proxy verification request message to the third peer node.

11. The identifier verification method of claim 9, further comprising:
determining whether the identifier is reliable according to a result of the identifier verification performed by the second peer node and selecting a new identifier proxy verifier when the identifier is not reliable; and
requesting the identifier verification to the second peer node via the selected new identifier proxy verifier.

12. The identifier verification method of claim 1, wherein the verifying reliability of the identifier of the second peer node comprises:
receiving an identifier verification authentication message including authentication information about a result of the identifier verification authentication, from the second peer node;
determining whether the identifier is reliable by checking the authentication information included in the identifier verification authentication message; and
notifying the user of one of success and failure of the identifier verification depending on a result of the determining whether the identifier is reliable.

13. An identifier verification method in a peer to peer network, a distributed peer to peer network without a server, the server having a plurality of peer nodes connected to an Internet, the identifier verification method comprising:
transmitting and receiving an identifier verification request message and a response message to obtain an identifier of a counterpart second peer node, the transmitting and receiving performed by a first peer node;
transmitting an identifier proxy verification request message to a third peer node randomly selected, the transmitting performed by the first peer node;
transmitting an identifier proxy verification transmission message to the second peer node when the third peer node receives the identifier proxy verification request message, the transmitting performed by the third peer node;
transmitting an identifier verification authentication message including authentication information obtained by performing the identifier verification authentication to the first peer node when the second peer node receives the identifier proxy verification transmission message, the transmitting performed by the second peer node; and
determining whether the identifier of the second peer node is reliable depending on the authentication information obtained from the identifier verification authentication message, the determining performed by the first peer node.

14. The identifier verification method of claim 13, further comprising selecting a new random proxy verifier and transmitting the identifier proxy verification request message to the selected proxy verifier when the authentication information determines the identifier verification to be a failure.

15. The identifier verification method of claim 13, wherein the transmitting an identifier proxy verification transmission message to the second peer node, the transmitting performed by the third peer node, comprises:
receiving the identifier proxy verification request message including a key value from the first peer node;
checking an electronic signature value included in the identifier proxy verification request message;
generating an identifier proxy verification transmission message including the key value when the electronic signature value is correct; and
transmitting the generated identifier proxy verification transmission message to the second peer node.

16. The identifier verification method of claim 13, wherein the transmitting an identifier verification authentication message including authentication information obtained by performing the identifier verification authentication to the first peer node, the transmitting performed by the second peer node comprises:
receiving the identifier proxy verification transmission message including the key value generated by the first peer node, from the third peer node;
checking the electronic signature value included in the identifier proxy verification transmission message;
checking whether information included in the identifier proxy verification transmission message is identical to information included in the identifier verification request message received previously from the first peer node when the electronic signature value is correct;
generating the identifier verification authentication message when the two information are identical to each other; and
transmitting the generated identifier verification authentication message to the first peer node.

17. The identifier verification method of claim 16, wherein the generating the identifier verification authentication message comprises:
decoding the key value included in the identifier proxy verification transmission message into a private key of the second peer node;
obtaining a new random one-time string value using the private key generated by the decoding and checking whether the random one-time string value of the second peer node transferred via the identifier proxy verification transmission message is identical to the random one-time string value previously generated by the second peer node; and
obtaining an authentication value using the new random one-time string value and a result of the checking.

18. The identifier verification method according to claim 17, wherein the key value is generated by Equation 5:
k=E_{P}_{ₜ}(Nᵥ|Nₜ) Equation 5
where Nᵥ denotes a random one-time string newly generated by the first peer node, and Nₜ denotes a random one-time string generated by the second peer node.

19. The identifier verification method of claim 15, wherein the identifier proxy verification message has a format satisfying Equation 6:
<“delegate_request”|sidₜ|sid_{d}|sidᵢ|k|Pᵢ|S_{R}_{ₜ}(sidₜ|sid_{d}|sidᵢ)> Equation 6
where “delegate_request” denotes a string indicating that the message is for the identifier proxy verification request, sidₜ denotes a session identifier of the second peer node, sid_{d} denotes a session identifier of the third peer node, sidᵢ denotes a session identifier of the first peer node, and S_{R}_{ₜ}(sidₜ|sid_{d}|sidᵢ) denotes the electronic signature value generated by the first peer node.

20. The identifier verification method of claim 19, wherein the session identifier of the third peer node is generated by Equation 7:
sid_{d}=h(ID_{d}|0|0|0|IP_{d}) Equation 7
where h denotes a cryptographic hash function, ID_{d} denotes the identifier of the third peer node, and IP_{d} denotes an IP address of the third peer node.

21. The identifier verification method of claim 15, wherein the identifier proxy verification transmission message is generated by Equation 8:
<“foward_delegate_request”|sidₜ|sidₜ|sid_{d}|k|P_{d}|S_{R}_{ᵢ}(sidₜ|sidₜ|sid_{d})> Equation 8
where “foward_delegate_request” denotes a string indicating that the message is for the identifier proxy verification transmission, sidₜ denotes the session identifier of the second peer node, sid_{d} denotes the session identifier of the third peer node, P_{d} and R_{d} denote a pair of a public key and a private key self-generated by the third peer node, respectively, and S_{R}_{_{d}}(sidₜ|sidₜ|sid_{d}) denotes an electrical signature value generated by the third peer node.

22. The identifier verification method of claim 17, wherein the authentication value is generated by Equation 9 when information included in the identifier proxy verification transmission message is identical to information included in the identifier verification request message:
pr=h(sidₜ|sidᵢ|Nᵥ) Equation 9

23. The identifier verification method of claim 9, further comprising:
selecting a new identifier proxy verifier to enhance reliability of the identifier verification even when the identifier is determined to be reliable according to a result of the identifier verification performed by the second peer node; and
requesting the second peer node for the identifier verification via the selected new identifier proxy verifier.

24. The identifier verification method of claim 23, wherein the identifier verification is repeated three and four times to enhance the reliability of the identifier verification.

25. The identifier verification method according to claim 10, wherein the key value is generated by Equation 5:
k=E_{P}_{ₜ}(Nᵥ|Nₜ) Equation 5
where Nᵥ denotes a random one-time string newly generated by the first peer node, and Nₜ denotes a random one-time string generated by the second peer node.
